(19) United States
(12) Patent Application Publication
(10) Pub. No.: US 2012/0201447 A1
(43) Pub. Date: Aug. 9, 2012

(54) Methods And Apparatuses For Correcting A Mask Layout

(76) Inventor: Seong-Bo Shim, Suwon-si (KR)

(21) Appl. No.: 13/351,527

(22) Filed: Jan. 17, 2012

(30) Foreign Application Priority Data
Feb. 7, 2011 (KR) 10-2011-0010737

(51) Int. Cl. G06K 9/03

(52) U.S. Cl. 382/144

(57) ABSTRACT

Methods of correcting a mask layout are provided. The methods may include acquiring two-dimensional (2D) geometry information of a mask pattern. The methods may further include acquiring an After Development Inspection (ADI) image parameter of the mask pattern. The methods may additionally include calculating an etch skew using the 2D geometry information and the ADI image parameter.

### CROSS-REFERENCE TO RELATED APPLICATIONS

This U.S. non-provisional patent application claims priority under 35 U.S.C. §119 to Korean Patent Application No. 10-2011-0010737, filed on Feb. 7, 2011, the disclosure of which is hereby incorporated by reference in its entirety.

### BACKGROUND

The present disclosure herein relates to methods and apparatuses for correcting a mask layout.

A process of patterning a semiconductor device may be performed through a photolithography process and an etching process. As the photolithography and etching processes are performed, differences may occur between a mask layout and a circuit pattern that is actually formed on a wafer. For example, differences occurring in the photolithography process may be caused/exacerbated by an optical proximity effect, and differences occurring in the etching process may be caused/exacerbated by a loading effect.

A process proximity correction (PPC) is a technique that attempts to correct a mask layout in advance (e.g., before forming a circuit pattern on a wafer) by estimating and analyzing primary factors in the photolithography and etching processes. The PPC may be classified as a rule-based type or a model-based type. The rule-based type may consider a sizing factor by dividing an area by pattern sizes, and the model-based type may use a model type in an attempt to correct the process proximity effect.

The PPC may calculate and estimate an etch skew of a circuit pattern that is formed on a wafer by using two-dimensional (2D) geometry information of a mask pattern. For example, if the 2D geometry information of the mask pattern is the same, it is estimated that the same etch skew is generated. However, even if the 2D geometry information is substantially the same, two circuit patterns having different etch skews may exist. This is because the circuit pattern may be differently formed according to the topology of the mask pattern.

### SUMMARY

According to some embodiments, methods of correcting a mask layout may include acquiring two-dimensional (2D) geometry information of a mask pattern. The methods may also include acquiring an After Development Inspection (ADI) image parameter of the mask pattern, The methods may additionally include calculating an etch skew using the 2D geometry information and the ADI image parameter.

In some embodiments, calculating the etch skew may include using a sum of the 2D geometry information and the ADI image parameter.

In some embodiments, calculating the etch skew further includes calculating the equation

$$b = {c}_{0} + {\sum }_{j = 1}^{N} {d}_{j} {Q}_{j} ( x , y ) + {\sum }_{i = 1}^{M} {c}_{i} {D}_{i} ( {s}_{i} , {u}_{i} ; x , y ) ,$$

where cₒ denotes an offset value, where cᵢ denotes a coefficient value of at least one kernel, where Dᵢ(sᵢ,uᵢ;x,y) denotes the at least one kernel at a target point (x, y), where dⱼ denotes a coefficient value of the ADI image parameter, and where Qⱼ(x,y) denotes the ADI image parameter at the target point (x, y).

In some embodiments, calculating the etch skew may include multiplying the 2D geometry information and the ADI image parameter.

In some embodiments, calculating the etch skew further includes calculating the equation

$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) ,$$

where cₒ denotes an offset value, where cᵢ denotes a coefficient value of at least one kernel, where Dᵢ(sᵢ,uᵢ;x,y) denotes the at least one kernel at a target point (x,y), where dⱼ denotes a coefficient value of the ADI image parameter, and where Qⱼ(x,y) denotes the ADI image parameter at the target point (x, y).

In some embodiments, the 2D geometry information may include at least one kernel.

In some embodiments, the 2D geometry information may include at least one of a visible kernel, a blocked kernel, and a density kernel.

In some embodiments, the ADI image parameter may include at least one of Image Log Slope (ILS), intensity slope (Islope), maximum intensity size (Imax), minimum intensity size (Imin), bending degree (Icurv), critical dimension (CD), and contrast.

In some embodiments, the 2D geometry information may include a plurality of 2D geometry information such that the 2D geometry information reflects a topology of the mask pattern.

According to some embodiments, methods of correcting a mask layout may include acquiring 2D geometry information of a mask pattern at a plurality of depths of the mask pattern. The methods may also include acquiring an After Development Inspection (ADI) image parameter for a three-dimensional (3D) image of the mask pattern. The methods may additionally include calculating an etch skew using the 2D geometry information and the ADI image parameter.

In some embodiments, calculating the etch skew further includes calculating an equation that includes an offset value, a coefficient value of a kernel, a depth of the mask pattern, and a kernel at a target point (x, y) and at the depth.

According to some embodiments, apparatuses for correcting a mask layout may include a first storage unit configured to store 2D geometry information of a mask pattern. The apparatuses may also include a second storage unit configured to store an ADI image parameter of the mask pattern. The apparatuses may additionally include an estimator unit configured to calculate an etch skew using the 2D geometry information and the ADI image parameter.

In some embodiments, the etch skew may be calculated using a sum of the 2D geometry information and the ADI image parameter.

In some embodiments, the etch skew may be calculated by the equation

$$b = {c}_{0} + {\sum }_{j = 1}^{N} {d}_{j} {Q}_{j} ( x , y ) + {\sum }_{i = 1}^{M} {c}_{i} {D}_{i} ( {s}_{i} , {u}_{i} ; x , y ) ,$$

where cₒ denotes an offset value, where cᵢ denotes a coefficient value of at least one kernel, where Dᵢ(sᵢ,uᵢ;x,y) denotes the at least one kernel at a target point (x,y), where dⱼ denotes a coefficient value of the ADI image parameter, and where Qⱼ(x,y) denotes the ADI image parameter at the target point (x,y).

In some embodiments, the etch skew may be calculated by multiplying the 2D geometry information and the ADI image parameter.

In some embodiments, the etch skew may be calculated by the equation

$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) ,$$

where cₒ denotes an offset value, where cᵢ denotes a coefficient value of at least one kernel, where Dᵢ(sᵢ,uᵢ;x,y) denotes the at least one kernel at a target point (x,y), where dⱼ denotes a coefficient value of the ADI image parameter, and where Qⱼ(x,y) denotes the ADI image parameter at the target point (x, y).

In some embodiments, the 2D geometry information may include at least one of a visible kernel, a blocked kernel, and a density kernel.

In some embodiments, the 2D geometry information may be acquired at a plurality of depths of the mask pattern.

In some embodiments, the ADI image parameter may include at least one of Image Log Slope (ILS), intensity slope (Islope), maximum intensity size (Imax), minimum intensity size (Imin), bending degree (Icurv), critical dimension (CD), and contrast.

In some embodiments, the 2D geometry information may include a plurality of 2D geometry information such that the 2D geometry information reflects a topology of the mask pattern.

### BRIEF DESCRIPTION OF THE DRAWINGS

The above and other features and advantages of the disclosure will become more apparent in view of the attached drawings and accompanying detailed description.

FIG. 1 is a flowchart illustrating a method of correcting a mask layout according to some embodiments;

FIGS. 2 to 4 are diagrams illustrating a visible kernel, a blocked kernel, and a density kernel, respectively, according to some embodiments;

FIGS. 5 and 6 are diagrams illustrating After Development Inspection (ADI) image parameters according to some embodiments;

FIG. 7 is a diagram illustrating a method of correcting a mask layout according to some embodiments;

FIG. 8 is a block diagram illustrating a configuration of an apparatus for correcting a mask layout according to some embodiments, and

FIG. 9 is a block diagram illustrating a configuration of an apparatus for correcting a mask layout according to some embodiments.

### DETAILED DESCRIPTION

Example embodiments are described below with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity. Like reference numbers refer to like elements throughout.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, integers, steps, operations, elements, and/or components, but do not preclude the presence or addition of one or more other features, integers, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

It will be understood that although the terms first, second, etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

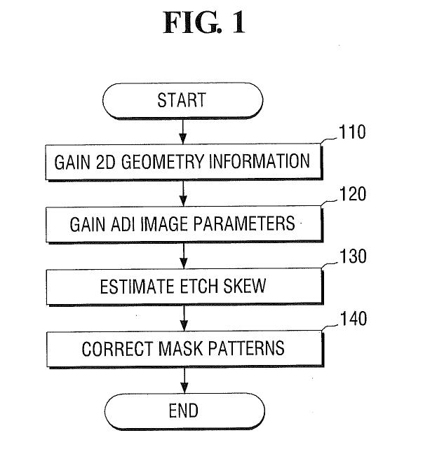

FIG. 1 is a flowchart illustrating a method of correcting a mask layout according to some embodiments. In particular, referring to FIG. 1, two-dimensional (2D) geometry information is acquired (Block 110). The 2D geometry information may include at least one kernel (e.g., one kernel or a plurality of different kernels). The kernel may be a model that indicates an etch process in consideration of a process proximity effect (PPE), and may be called a process proximity correction (PPC) model or a process model. The symbols sᵢ and uᵢ denote variables that define the characteristics of a kernel, and Dᵢ(sᵢ,uᵢ;x,y) denotes a kernel at a target point (x, y). For example, the symbol sᵢ indicates a range around a 2D position (x, y), and the symbol uᵢ may be a Gaussian width.

The kernel may be, for example, a visible kernel, a blocked kernel, or a density kernel. Also, the 2D geometry information may include at least one of the visible kernel, the blocked kernel, and the density kernel.

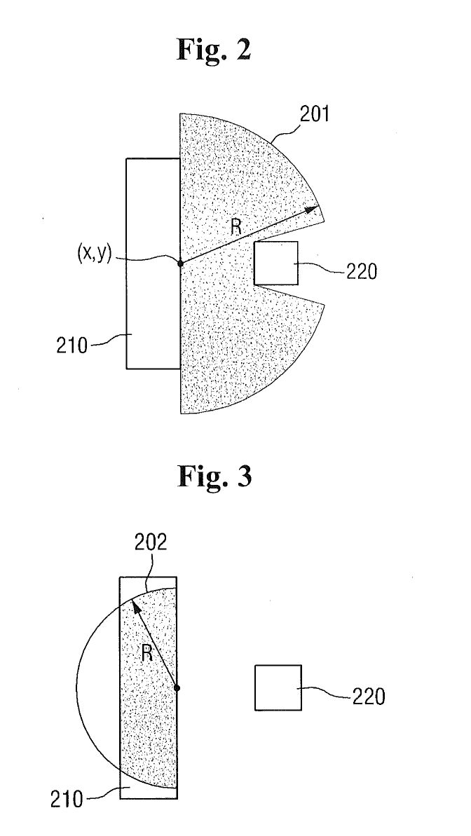

For example, FIGS. 2 to 4 are diagrams illustrating a visible kernel, a blocked kernel, and a density kernel, respectively, according to some embodiments. For convenience of explanation, a first pattern 210 and a second pattern 220 are illustrated in FIGS. 2 to 4, and the target point (x, y) is positioned on the first pattern 210.

Referring to FIG. 2, a visible kernel 201 represents the influence that is exerted on an etch amount by the second pattern 220 and its surrounding space when the target point (x, y) of the first pattern 210 is etched. In other words, the visible kernel 201 represents relative relations that the first pattern 210 forms with the second pattern 220 and its surrounding space.

Referring to FIG. 3, a blocked kernel 202 represents the influence that is exerted on the etch amount of the target point (x, y) by the characteristics of the first pattern 210 that is in contact with the target point (x, y) although the second pattern 220 is not. In other words, the blocked kernel 202 represents the relations that the shape of the first pattern 210 itself makes with the etch characteristics.

Referring to FIG. 4, a density kernel 203 represents the influence that is exerted on the etch amount of the target point (x, y) by a pattern density surrounding the target point (x, y). In other words, unlike the visible kernel 201 or the blocked kernel 202 that divides the influence into an outer influence and an inner influence from the target point (x, y), the density kernel 203 represents the relations with all patterns (e.g., both the first pattern 210 and the second pattern 220) in a specified area.

On the other hand, as shown in the following Equation (1), the two-dimensional (2D) geometry information k may be expressed, for example, as the sum of at least one kernel Dᵢ(sᵢ,uᵢ;x,y). Referring to Equations (1) and (2), M is a natural number that is equal to or larger than 1, and cᵢ represents a coefficient/weight value of the kernel Dᵢ(sᵢ,uᵢ;x,y). Equation (1) may be rewritten and expressed as shown in Equation (2). In Equation (2), for example, Dᵢ(sᵢ;uᵢ;x,y) may be the visible kernel, D₂(s₂,u₂;x,y) may be the blocked kernel, and D₃(s₃,u₃;x,y) may be the density kernel. Equation (2) represents an example in the case where the coefficient/weight value of the visible kernel Dᵢ(sᵢ,uᵢ;x,y) is set to 5, and the coefficients/weight values of the blocked kernel D₂(s₂,u₂;x,y) and the density kernel D₃(s₃,u₃;x,y) are set to 1.

$$\begin{matrix}k = {\sum }_{i = 1}^{M} {c}_{l} {D}_{l} ( {s}_{l} , {u}_{l} ; x , y ) & Equation ( 1 ) \\ k = {\sum }_{i = 1}^{M} {c}_{i} {D}_{i} ( {s}_{i} , {u}_{i} ; x , y ) = 5 {D}_{1} ( {s}_{1} , {u}_{1} ; x , y ) + {D}_{2} ( {s}_{2} , {u}_{2} ; x , y ) + {D}_{3} ( {s}_{3} , {u}_{3} ; x , y ) & Equation ( 2 )\end{matrix}$$

Referring again to FIG. 1, after acquiring the 2D geometry information (Block 110), one or more After Development Inspection (ADI) image parameters may be acquired (Block 120).

The ADI image parameters may include a large number of parameters related to a three-dimensional (3D) image of the mask pattern after development. For example, the ADI image parameters may include at least one of maximum intensity size (Imax), minimum intensity size (Imin), intensity slope (Islope), contrast, Image Log Slope (ILS), Critical Dimension (CD), and bending degree (Icurv).

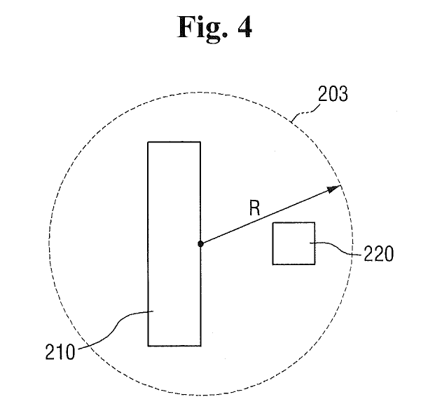

FIGS. 5 and 6 are diagrams illustrating After Development Inspection (ADI) image parameters according to some embodiments.

Referring to FIG. 5, Imax represents the maximum intensity size of the mask pattern 310, and Imin represents the minimum intensity size of the mask pattern 310. Islope(x,y) represents the intensity slope at the target point (x, y) of the intensity distribution of the mask pattern 310. Contrast may be expressed as shown in Equation (3). ILS(x,y) may be expressed as shown in Equation (4). Also, CD represents a distance between the etched mask patterns 310 and 320.

$$\begin{matrix}contrast = \frac{I max - I min}{I max + I min} & Equation ( 3 ) \\ ILS ( x , y ) = \frac{1}{I} \times \frac{d I}{d x} & Equation ( 4 )\end{matrix}$$

Referring to FIG. 6, Icurve represents the bending degree (1/r1) of the mask pattern 330.

On the other hand, as shown in the following Equation (5), the ADI image parameter (g) may be expressed as the sum of at least one of Qⱼ(x,y). Here, Qⱼ(x,y) may represent any one of ADI image parameters such as Imax, Imin, Islope, contrast, Image Log Slope (ILS), Critical Dimension (CD), and Icurv. Still referring to Equation (5), N is a natural number that is equal to or larger than 1, and dⱼ represents a coefficient/weight value. Also, Equation (5) may be rewritten and expressed as shown in Equation (6). In Equation (6), the coefficient/weight value of ILS(x,y) is set to 3, and the coefficient/weight value of contrast(x,y) is set to 4.

$$\begin{matrix}g = {\sum }_{j = 1}^{N} {d}_{j} {Q}_{j} ( x , y ) & Equation ( 5 ) \\ g = {\sum }_{j = 1}^{N} {d}_{j} {Q}_{j} ( x , y ) = 3 ILS ( x , y ) + … + 4 contrast ( x , y ) & Equation ( 6 )\end{matrix}$$

Referring again to FIG. 1, after acquiring the ADI image parameters (Block 120), the etch skew may be estimated/calculated using the 2D geometry information and one or more ADI image parameters (Block 130).

For example, the etch skew may be calculated using the sum of the 2D geometry information and one or more ADI image parameters. In one example, the etch skew b may be expressed as shown in Equation (7). Referring to Equation (7), cₒ denotes an offset value, and dⱼ, (x,y), Dᵢ(sᵢ,uᵢ;x,y) and the like, may be as described above.

$$b = {c}_{0} + {\sum }_{j = 1}^{N} {d}_{j} {Q}_{j} ( x , y ) + {\sum }_{i = 1}^{M} {c}_{i} {D}_{i} ( {s}_{i} , {u}_{i} ; x , y ) \qquad Equation ( 7 )$$

Alternatively, the etch skew may be calculated by multiplying the 2D geometry information and one or more ADI image parameters. For example, the etch skew b may be expressed as shown in Equation (8).

$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) \qquad Equation ( 8 )$$

Referring again to FIG. 1, after calculating the etch skew (Block 130), the calculated etch skew may be used to improve/correct the mask pattern (Block 140).

The method of improving/correcting the mask layout according to some embodiments includes calculating the etch skew using both the 2D geometry information of the mask pattern and the ADI image parameter(s). In other words, because the topology shape of the mask pattern is considered, the etch skew can be calculated more accurately.

Further, because the coefficients/weight values are given to the 2D geometry information and the ADI image parameter(s), a larger coefficient/weight value can be given to an element that exerts more influence on the etch skew. Accordingly, the etch skew can be calculated more accurately, and as a result, pattern fidelity can be improved/increased.

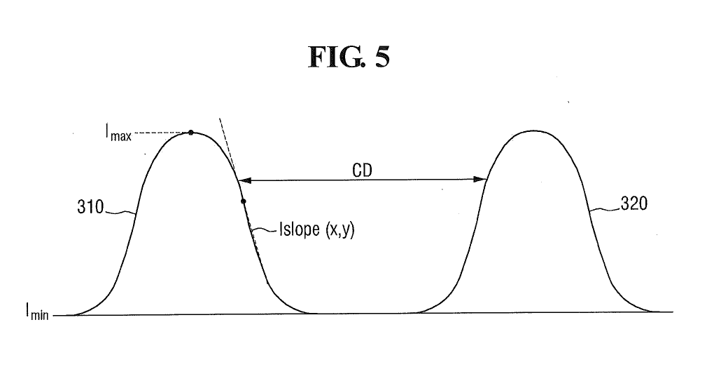

FIG. 7 is a diagram illustrating a method of correcting a mask layout according to some embodiments. Referring to FIG. 7, the 2D geometry information of the mask pattern may be calculated at a plurality of depths (e.g., for each depth) of the mask pattern, and the etch skew may be calculated using the calculated depths. In other words, the 2D geometry information of the mask pattern may be processed/calculated to reflect the topology of the mask pattern.

As illustrated in FIG. 7, the mask pattern 310 may have different 2D geometry information for each depth z. For example, the width of the mask pattern 310 when z=0 may be wider than the width of the mask pattern 310 when z=z_{d}. Accordingly, consideration of the 2D geometry information based on depth (e.g., including information calculated at a plurality of depths) can help to calculate the etch skew more accurately.

The above-described etch skew may be calculated as shown in Equation (9). Also, Equation (10) illustrates the calculation of etch skew where the etch skew is calculated by calculating the 2D geometry information for each depth (that is, from depth z=0 to depth z_{d}) as illustrated in FIG. 7.

$$\begin{matrix}b = {c}_{0} + {\sum }_{z} {\sum }_{i = 1}^{M} {c}_{i} {D}_{i} ( {s}_{i} , {u}_{i} ; x , y , z ) & Equation ( 9 ) \\ b = {c}_{0} + {\sum }_{i = 1}^{M} {c}_{i} {D}_{i} ( {s}_{i} , {u}_{i} ; x , y , 0 ) + {\sum }_{i = 1}^{M} {c}_{i} {D}_{i} ( {s}_{i} , {u}_{i} ; x , y , {z}_{a} ) + {\sum }_{i = 1}^{M} {c}_{i} {D}_{i} ( {s}_{i} , {u}_{i} ; x , y , {z}_{b} ) + {\sum }_{i = 1}^{M} {c}_{i} {D}_{i} ( {s}_{i} , {u}_{i} ; x , y , {z}_{c} ) + {\sum }_{i = 1}^{M} {c}_{i} {D}_{i} ( {s}_{i} , {u}_{i} ; x , y , {z}_{d} ) & Equation ( 10 )\end{matrix}$$

On the other hand, as shown in Equations (11) and (12), the etch skew may be calculated using the ADI image parameter(s) in addition to using all of the 2D geometry information of the mask pattern that reflects the topology of the mask pattern. Equation (11) uses the sum of the 2D geometry information and the ADI image parameter(s), and Equation (12) multiplies the 2D geometry information and the ADI image parameter(s).

$$\begin{matrix}b = {c}_{0} + {\sum }_{z} {\sum }_{i = 1}^{M} {c}_{i} {D}_{i} ( {s}_{i} , {u}_{i} ; x , y , z ) + {\sum }_{i = 1}^{M} {c}_{i} {D}_{i} ( {s}_{i} , {u}_{i} ; x , y ) & Equation ( 11 ) \\ b = {c}_{0} + {\sum }_{z} {\sum }_{i = 1}^{M} {c}_{i} {D}_{i} ( {s}_{i} , {u}_{i} ; x , y , z ) \times {\sum }_{i = 1}^{M} {c}_{i} {D}_{i} ( {s}_{i} , {u}_{i} ; x , y ) & Equation ( 12 )\end{matrix}$$

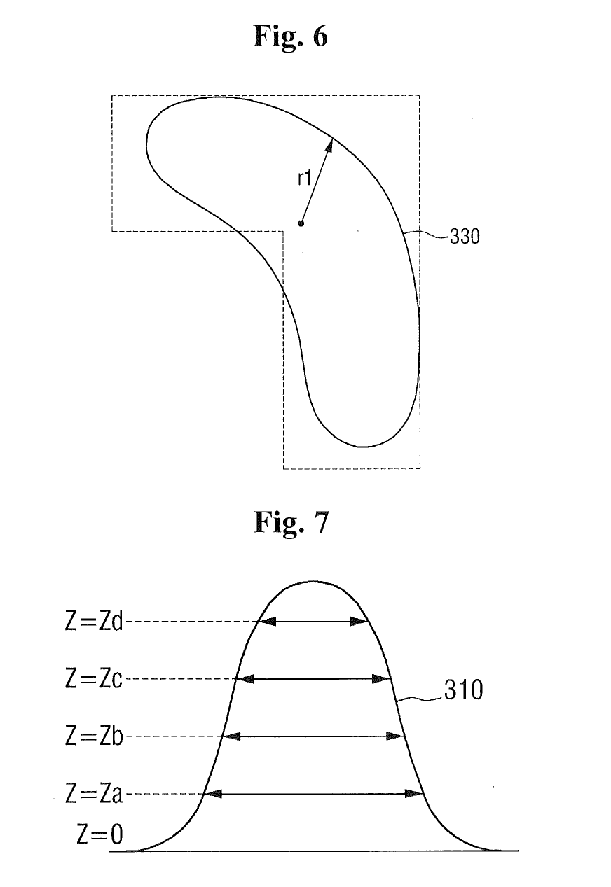

FIG. 8 is a block diagram illustrating the configuration of an apparatus 1 for correcting a mask layout according to some embodiments.

Referring to FIG. 8, the apparatus 1 for correcting a mask layout may include a first storage unit 410, a second storage unit 420, and an estimator unit 430.

The first storage unit 410 may store the 2D geometry information of the mask pattern. As described above, the 2D geometry information may include at least one kernel. For example, the 2D geometry information may include at least one of the visible kernel, the blocked kernel, and the density kernel. As shown in the above-described Equation (1), the 2D geometry information k may be expressed as the sum of at least one kernel.

The second storage unit 420 may store the ADI image parameter of the mask pattern. As described above, the ADI image parameter may include a large number of parameters related to the 3D image of the mask pattern. For example, the ADI image parameter may include at least one of Imax, Imin, Islope, contrast, Image Log Slope (ILS), Critical Dimension (CD), and Icurv. The ADI image parameter (g) may be expressed as the sum of several Qⱼ(x,y) as shown in Equation (5). Here, Qⱼ(x,y) may be any one of Imax, Imin, Islope, contrast, Image Log Slope (ILS), Critical Dimension (CD), and Icurv.

The estimator unit 430 may estimate/calculate the etch skew of the mask pattern using the 2D geometry information and the ADI image parameter. The etch skew may be calculated using the sum of the 2D geometry information and the ADI image parameter. For example, the etch skew may be expressed as shown in Equation (7). Alternatively, the etch skew may be calculated by multiplying the 2D geometry information and the ADI image parameter. For example, the etch skew may be expressed as shown in Equation (8).

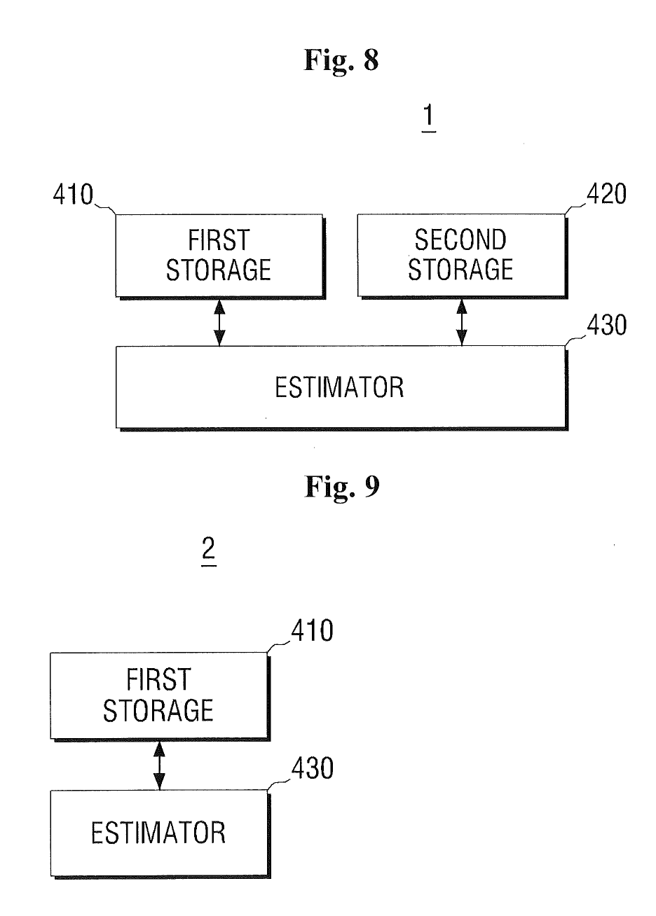

FIG. 9 is a block diagram illustrating the configuration of an apparatus 2 for correcting a mask layout according to some embodiments. Referring to FIG. 9, the apparatus 2 for correcting a mask layout according to some embodiments may include a first storage unit 410 and an estimator unit 430. The first storage unit 410 may include the 2D geometry information of the mask pattern that reflects the topology of the mask pattern. The estimator unit 430 of the apparatus 2 may estimate/calculate the etch skew using the 2D geometry information of the mask pattern that is stored in the first storage unit 410.

While the inventive concept has been particularly shown and described with reference to various embodiments thereof, it will be understood by those of ordinary skill in the art that various changes in form and details may be made therein without departing from the spirit and scope of the inventive concept as defined by the following claims. Therefore, the above-disclosed subject matter is to be considered illustrative and not restrictive.

What is claimed is:

1. A method of correcting a mask layout, comprising:
acquiring two-dimensional (2D) geometry information of a mask pattern;
acquiring an After Development Inspection (ADI) image parameter of the mask pattern; and
calculating an etch skew using the 2D geometry information and the ADI image parameter.

2. The method of claim 1, wherein calculating the etch skew comprises using a sum of the 2D geometry information and the ADI image parameter.

3. The method of claim 2, wherein calculating the etch skew further comprises calculating the equation
$$b = {c}_{0} + {\sum }_{j = 1}^{N} {d}_{j} {Q}_{j} ( x , y ) + {\sum }_{i = 1}^{M} {c}_{i} {D}_{i} ( {s}_{i} , {u}_{i} ; x , y ) ,$$
wherein cₒ denotes an offset value, wherein cᵢ denotes a coefficient value of at least one kernel, wherein Dᵢ(sᵢ;uᵢ;x,y) denotes the at least one kernel at a target point (x,y), wherein dⱼ denotes a coefficient value of the ADI image parameter, and wherein Qⱼ(x,y) denotes the ADI image parameter at the target point (x,y).

4. The method of claim 1, wherein calculating the etch skew comprises multiplying the 2D geometry information and the ADI image parameter.

5. The method of claim 4, calculating the etch skew further comprises calculating the equation
$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) ,$$
wherein cₒ denotes an offset value, wherein cᵢ denotes a coefficient value of at least one kernel, wherein Dᵢ(sᵢ,uᵢ;x,y) denotes the at least one kernel at a target point (x,y), wherein dⱼ denotes a coefficient value of the ADI image parameter, and wherein Qⱼ(x,y) denotes the ADI image parameter at the target point (x,y).

6. The method of claim 1, wherein the 2D geometry information includes at least one kernel.

7. The method of claim 6, wherein the 2D geometry information includes at least one of a visible kernel, a blocked kernel, and a density kernel.

8. The method of claim 1, wherein the ADI image parameter includes at least one of Image Log Slope (ILS), intensity slope (Islope), maximum intensity size (Imax), minimum intensity size (Imin), bending degree (Icurv), critical dimension (CD), and contrast.

9. The method of claim 1, wherein the 2D geometry information includes a plurality of 2D geometry information such that the 2D geometry information reflects a topology of the mask pattern.

10. A method of correcting a mask layout comprising:
acquiring 2D geometry information of a mask pattern at a plurality of depths of the mask pattern;
acquiring an After Development Inspection (ADI) image parameter for a three-dimensional (3D) image of the mask pattern; and
calculating an etch skew using the 2D geometry information and the ADI image parameter.

11. The method of claim 10, wherein calculating the etch skew further comprises calculating an equation that includes an offset value, a coefficient value of a kernel, a depth of the mask pattern, and a kernel at a target point (x,y) and at the depth.

12. An apparatus for correcting a mask layout, comprising:
a first storage unit configured to store 2D geometry information of a mask pattern;
a second storage unit configured to store an ADI image parameter of the mask pattern; and
an estimator unit configured to calculate an etch skew using the 2D geometry information and the ADI image parameter.

13. The apparatus of claim 12, wherein the etch skew is calculated using a sum of the 2D geometry information and the ADI image parameter.

14. The apparatus of claim 13, wherein the etch skew is calculated by the equation
$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) ,$$
wherein cₒ denotes an offset value, wherein cᵢ denotes a coefficient value of at least one kernel, wherein Dᵢ(sᵢ,uᵢ;x,y) denotes the at least one kernel at a target point (x,y), wherein dⱼ denotes a coefficient value of the ADI image parameter, and wherein Qⱼ(x,y) denotes the ADI image parameter at the target point (x,y).

15. The apparatus of claim 12, wherein the etch skew is calculated by multiplying the 2D geometry information and the ADI image parameter.

16. The apparatus of claim 15, wherein the etch skew is calculated by the equation
$$b = {c}_{0} + {\sum }_{j = 1}^{N} {d}_{j} {Q}_{j} ( x , y ) \times {\sum }_{i = 1}^{M} {c}_{i} {D}_{i} ( {s}_{i} , {u}_{i} ; x , y ) ,$$
wherein cₒ denotes an offset value, wherein cᵢ denotes a coefficient value of at least one kernel, wherein Dᵢ(sᵢ,uᵢ;x,y) denotes the at least one kernel at a target point (x,y), wherein dⱼ denotes a coefficient value of the ADI image parameter, and wherein Qⱼ(x,y) denotes the ADI image parameter at the target point (x,y).

17. The apparatus of claim 12, wherein the 2D geometry information includes at least one of a visible kernel, a blocked kernel, and a density kernel.

18. The apparatus of claim 12, wherein the 2D geometry information is acquired at a plurality of depths of the mask pattern.

19. The apparatus of claim 12, wherein the ADI image parameter includes at least one of Image Log Slope (ILS), intensity slope (Islope), maximum intensity size (Imax), minimum intensity size (Imin), bending degree (Icurv), critical dimension (CD), and contrast.

20. The apparatus of claim 12, wherein the 2D geometry information includes a plurality of 2D geometry information such that the 2D geometry information reflects a topology of the mask pattern.
